(19) United States
(12) Patent Application Publication
(10) Pub. No.: US 2024/0293836 A1
(43) Pub. Date: Sep. 5, 2024

(54) Application System Comprising A Connection Piece With A Filter Insert Arranged Therein And A Heating Hose Having Such A Connection Piece

(71) Applicant: Robatech AG, Muri (CH)

(72) Inventors: Michael Hürlimann, Bremgarten (CH); Claudio Hofer, Hagendorn (CH); Stephan Knecht, Beinwil am See (CH)

(73) Assignee: Robatech AG, Muri (CH)

(21) Appl. No.: 18/593,169

(22) Filed: Mar. 1, 2024

(30) Foreign Application Priority Data
Mar. 3, 2023 (EP) 23 159 957.2

(51) Int. Cl. B05C 5/00; B01D 29/11; B05C 5/02

(52) U.S. Cl. CPC B05C 5/001; B01D 29/114; B05C 5/0225; B01D 2201/291

(57) ABSTRACT

An application system for applying a flowable medium, in particular a hot melt adhesive, to a substrate, and a heating hose for supplying a flowable medium to an application device for applying the flowable medium to a substrate. In the application system, the application device and the heating hose are coupled detachably to one another via a connection piece, wherein the connection piece has a receiving section for a filter insert.

### FIELD OF THE INVENTION

The present invention relates to an application system for applying a flowable medium, in particular a hot melt adhesive, to a substrate. The present invention also relates to a heating hose for supplying a flowable medium to an application device for applying the flowable medium to a substrate.

### BACKGROUND OF THE INVENTION AND RELATED ART

In a wide variety of industries, hot-melting flowable media, for example hot melt adhesives, are used to join parts to one another. Hot melt adhesives are used for example in the production of packaging, such as folding boxes or trays, or else in the graphical industry, the construction industry and wood industry, and for the production of mattresses. Such flowable media must generally be transferred from a solid state into a liquid state or pasty state by the action of heat before processing. The liquefied flowable medium is then supplied via a heatable heating hose to an application device for applying the flowable medium. The heating hose is thus used as a heated and flexible transport path for the flowable medium. The application device can be, for example, a hand spray gun or an application head, in particular an application head provided with a dosing valve. This application device is generally heatable in order to keep the flowable medium at a temperature necessary for processing or within a certain temperature range.

To avoid contamination and thus impaired function of the application device, filter devices are usually provided in the region of the application device. These filter devices usually have a filter basket, with a woven filter fabric, generally in the form of a woven metal fabric, being arranged on the filter basket, and flow passing through the filter basket and the woven filter fabric radially inwards from the radial outside. Any dirt present in the flowable medium then accumulates on the outside of the woven filter fabric. With a filter arranged in the application device, there is the problem that some of the filtered dirt remains in the receiving space for the filter when the filter is exchanged. When a new filter is inserted, there is then the risk that some of the dirt remaining in the application device will get into a region for filtered flowable medium. As a result, impaired function of the application device and/or contamination of the dispensed flowable medium can occur. This is a particular problem when there is a dosing valve arranged downstream of the filter and/or a nozzle of the application device arranged downstream of the filter.

An apparatus for applying heated adhesive or hot glue having at least one application head and a filter integrated in the application head is known for example from DE 20 2008 007 386 U1.

However, application systems for applying a flowable medium to a substrate are also known in which the application system has a heating hose for supplying the flowable medium to an application device, wherein a filter device is arranged inside the heating hose. Such an application system is described for example in U.S. Pat. No. 4,524,887 A. A disadvantage of the design described in the aforementioned document is that a filter change is very laborious owing to the arrangement of the filter in the heating hose and the fastening of the filter in the heating hose. In addition, it is not possible to change the filter without tools.

### OBJECT OF THE INVENTION

The object of the present invention is to specify an application system for applying a flowable medium which overcomes the aforementioned disadvantages. It is also an object of the present invention to specify a heating hose which overcomes the aforementioned disadvantages.

This object is achieved by an application system having the features disclosed herein. This object is also achieved by a heating hose having the features disclosed herein.

### SUMMARY OF THE INVENTION

The application system according to the present invention is used to apply a flowable medium to a substrate. The flowable medium is in particular a molten hot melt adhesive. The application system has a heatable application device for applying the flowable medium to the substrate. The application system also has a heating hose for supplying the flowable medium to the application device, the heating hose having an inner tube for conducting the flowable medium. The application system also comprises a filter insert for filtering the flowable medium. The application device is in particular an application head, preferably with a pneumatically or electrically operated dosing valve for dispensing the flowable medium from an application nozzle of the application head. The application device and the heating hose are coupled to one another detachably via a connection piece. The connection piece has an inlet end, which is fluid-connected to the inner tube and has an inlet opening for the flowable medium, an outlet end, which has an outlet opening, and a through-duct, which extends from the inlet opening to the outlet opening, for the flowable medium. At its outlet end, the connection piece has a coupling section, which extends in a straight line in an axial direction and is coupled detachably to the application device. The filter insert is inserted through the outlet opening in a straight line in the axial direction into a receiving section formed by the through-duct. The filter insert has a filter structure through which flow can pass radially inwards from the radial outside or radially outwards from the radial inside, for filtering the flowable medium. The filter insert has a bearing section, which protrudes radially outwards relative to the filter structure, the bearing section being arranged at least partially in the receiving section, for radially supporting the filter insert in the receiving section.

This design makes it possible to remove the filter insert from the receiving section or insert it into the receiving section from the outlet opening in the axial direction when the connection piece is disconnected from the application device. This enables particularly simple and fast changing of the filter insert, for example when the filter insert is dirty. The bearing section ensures that the filter insert, more precisely the filter structure, is spaced in the radial direction from an inner wall or inner side of the connection piece which delimits the through-duct, in order to allow a radial flow through the filter structure, radially inwards from the radial outside or radially outwards from the radial inside, over the entire circumferential face of the filter structure. In this respect, a centering of the filter structure in the receiving section is achieved by the bearing section.

A filter structure through which flow passes radially inwards from the radial outside or radially outwards from the radial inside has the advantage of a lower flow resistance and a longer service life in comparison with a filter structure through which flow passes axially, since a filter structure through which flow passes axially has a smaller filter area with comparable radial dimensions, as a result of which it has a higher flow resistance during operation and becomes blocked more quickly.

The arrangement of the filter insert in the through-duct means that a particularly homogeneous loading of the filter with the fluid to be filtered is achieved. This avoids dead spaces and/or congested spaces. In addition, a separate receiving space for the filter insert can be omitted, which makes a particularly compact design possible.

It is considered particularly advantageous when the bearing section is directly adjacent to the inner side of the connection piece which delimits the through-duct, wherein an outer diameter of the bearing section and a diameter of the receiving section are substantially identical. In this connection, it is considered particularly advantageous when the diameter of the receiving section and the outer diameter of the bearing section are dimensioned such that a radial clearance between the bearing section and the inner side which circumferentially delimits the through-duct, for example in the form of a clearance between an outer diameter of the bearing section and a diameter of the through-duct in the region of the receiving section, is smaller than or equal to an opening size or mesh width of the filter structure. This prevents a situation in which unfiltered fluid medium containing dirt particles greater than an opening size of the filter structure passes radially outwards through the filter insert and as a result is not filtered via the filter structure and thereby passes into the application device.

It is considered particularly advantageous when the bearing section interacts sealingly with the inner side of the application head which circumferentially delimits the receiving section, so that no flowable medium can pass radially outwards through the bearing section. The sealing effect can be aided by medium which has penetrated through in the intermediate region and possibly cured there.

Preferably, the receiving section is formed by a cylindrical bore. As a result, the receiving section can be produced particularly simply.

It is considered particularly advantageous when the outer diameter of the bearing section and the diameter of the receiving section are dimensioned closely to one another such that the filter insert is held in the receiving section. As a result, a situation is avoided in which the filter insert falls out of the receiving section, for example under gravity, when the connection piece is disconnected. Preferably, there is a clearance fit between the outer diameter of the bearing section and the diameter of the receiving section. Preferably, the diameters are dimensioned such that a force-fitting connection between the filter insert and the receiving section is effected in that flowable medium passes during operation into the interstice between the bearing section and the inner side of the connection piece which delimits the through-duct in the region of the receiving section, as a result of which an additional static friction is achieved between the mutually facing surfaces of the bearing section and the connection piece. This static friction or the force fit will generally prevent the filter insert from falling out under gravity. However, this force will not be so great that the filter insert can no longer be removed manually from the receiving section.

In a particularly preferred embodiment, no further sealing elements, such as an O-ring or similar, are arranged between the bearing section and the inner side of the connection piece which delimits the through-duct. This saves on parts subject to wear and aids reliable operation.

Preferably, the connection piece consists of metal or a metal alloy. Preferably, the bearing section likewise consists of metal or a metal alloy. Manufacture from metal has the advantage that the parts can be manufactured with low tolerances, as a result of which the precision of fit can be increased. In addition, metal or a metal alloy has low wear phenomena, and therefore a long service life is achieved. Preferably, the connection piece is formed integrally. Preferably, the connection piece is rigid.

In a particularly preferred embodiment, the bearing section has a hollow cylindrical design and in this respect has an interior duct for the flowable medium.

Against the background of the simplest possible installation and removal of the filter insert into and out of the receiving section, it is considered advantageous when no further mechanical securing means are provided, but the filter insert only has to be inserted into or pulled out of the receiving section in the axial direction, from the outlet opening to be turned towards the dispensing device, for the purpose of assembly or disassembly.

In a preferred embodiment, the application device is designed as an application head having a dosing valve, in particular a pneumatically operated dosing valve.

In a preferred embodiment, the receiving section has a diameter which is wider than the adjacent section of the through-duct in the direction of the heating hose. Because the through-duct has a smaller diameter adjacent to the receiving section, an insertion of the filter insert into the through-duct of the connection piece is limited.

The filter insert does not necessarily have to be inserted completely into the receiving section. In this respect, it is quite conceivable and preferred when a portion of the filter insert in the axial direction protrudes in the direction of the application device relative to the receiving section.

It is considered particularly advantageous when the filter insert has a supporting section, the filter insert being arranged in the receiving section such that the supporting section protrudes in the axial direction relative to the receiving section in the direction of the application device, the supporting section being supported axially on a counter bearing of the application device. The supporting section and the counter bearing prevent a situation in which the filter insert is pressed out of the receiving section during operation of the application system. The filter insert is held in position during operation of the application system by means of the supporting section and the counter bearings interacting with the supporting section. The pressurized flowable medium presses the filter insert against the counter bearing in the axial direction during operation.

With regard to the supporting section, it is considered particularly advantageous when the supporting section bears circumferentially and sealingly against the counter bearing during operation. This prevents flowable medium from leaking into this region.

It is considered particularly advantageous when the receiving section and the bearing section are cylindrical. A high precision of fit can thereby be achieved.

Preferably, a circumferential face of the bearing section is smooth, in particular free of a thread. This makes it easier to shift the bearing section in the receiving section.

In a particularly preferred embodiment, the coupling section can be inserted into the application device for the purpose of coupling the connection piece and the application device. In this respect, there is preferably a plug coupling, in particular a rapid coupling. It is considered advantageous here when the coupling section has an outer diameter which widens in steps in the direction of the heating hose, and a plug-in opening or connection socket of the application device has a corresponding inner diameter which widens in steps in the direction of the heating hose. The plug-in opening of the application device can for example be formed by a bore with multiple steps. The stepped diameters facilitate the coupling of the connection piece to the application device, since self-centering takes place as a result of the stepped diameters. In this connection, it is considered particularly advantageous when at least one transition between the steps is conical.

In connection with such a plug coupling between the connection piece and the application device, it is considered advantageous when the connection piece is secured axially via a closure slide which can be shifted transversely to the plug-in direction. During operation, the flowable medium is typically under high pressure, for example about 100 bar to about 300 bar. By means of the closure slide, a situation is avoided in which the connection piece is pressed out and thus the plug coupling comes undone owing to the pressure forces. In addition, the connection piece is thereby secured against being unintentionally removed. It is considered particularly advantageous here when the connection piece has a circumferential recess on its outer side, and the application device has a corresponding recess on an inner side at a plug-in opening for the connection piece, these two recesses forming a receiving region for two limbs of the closure slide when the connection piece is in the plugged-in position, the limbs preventing axial shifting of the connection piece relative to the plug-in opening by means of a form fit when the closure slide is plugged in.

To prevent escape of flowable medium in the coupling region between the connection piece and the application device, it is considered particularly advantageous when a portion of the bearing section protrudes in the axial direction relative to the receiving section. This avoids any dead spaces for the flowable medium.

In a particularly preferred embodiment, the bearing section is formed in an axial direction between an end, facing the application device, of the filter insert and the filter structure. The filter structure is thereby formed ahead of the bearing section when the filter insert is inserted into the receiving section. Since the filter structure has a smaller radial dimension than the bearing section, insertion is facilitated thereby, since initially the filter structure can be introduced into the receiving section in a simple manner before the bearing section has to be positioned as precisely as possible in terms of the alignment of the filter insert with the receiving section in order then to insert it into the receiving section.

In a particularly preferred embodiment, the filter insert has a further bearing section, the filter structure being formed between the one bearing section and the further bearing section, the further bearing section protruding radially outwards relative to the filter structure, for radially supporting the filter insert in the receiving section. The further bearing section prevents the filter insert from tilting or jamming, for example when being inserted. In addition, the further bearing section again results in the most precise positioning possible of the filter structure in the receiving section, in particular in a coaxial alignment of the filter structure with the receiving section, as a result of which the most uniform possible radial flow through the filter structure is achieved over the entire circumferential face of the filter structure. The insertion and removal of the filter insert is likewise simplified, since the further bearing section effects additional guidance of the filter insert. Preferably, an outer diameter of the further bearing section is slightly smaller than an outer diameter of the one bearing section, as a result of which the insertion and removal of the filter insert is made easier. The further bearing section also has the advantage of reliable centering of the filter insert during operation, in particular when the flowable medium is under high pressure. In particular when the flow is deflected in the region of the filter insert and/or shortly upstream of the filter insert, further support as effected by the further bearing section is particularly advantageous, since otherwise the filter insert could tilt or jam in the receiving section, which could have a negative effect on wear or even operation.

With regard to the further bearing section, it is considered particularly advantageous when the further bearing section has radially outwardly protruding pegs, so that a through-opening for the flowable medium to be filtered is formed between two pegs which are adjacent in the circumferential direction and a section, extending between the pegs, of the inner side which circumferentially delimits the through-duct. As a result, flowable medium to be filtered is allowed to flow into the region of the receiving section situated radially on the outside in relation to the filter insert, so that the flowable medium to be filtered then can flow radially inwards from the radial outside over the entire circumferential face of the filter structure and is filtered via the filter structure in the process. However, it is also conceivable in principle for the further bearing section to be provided with corresponding through-openings in order to allow inflow of the flowable medium to be filtered into the region of the receiving section situated radially on the outside in relation to the filter insert.

Alternatively, however, the filter insert can also be designed such that the flowable medium flows through the filter structure from the radial inside outwards.

In a particularly preferred embodiment, the filter insert has a main body and a woven filter fabric forming the filter structure. The woven filter fabric is in particular a wire mesh. The wire mesh preferably has a wire thickness of about 0.05 mm to about 0.2 mm.

The woven filter fabric is in particular hose-like or tubular. In this connection, it is considered particularly advantageous when the main body has a filter section and the bearing section, the bearing section and the filter section being adjacent to one another in the axial direction, the main body having an inner duct, which passes through the bearing section and extends into the filter section, for filtered flowable medium, the main body having through-openings which open into the inner duct in the region of the filter section, the woven filter fabric being arranged in the region of the filter section and circumferentially surrounding the filter section. Such a main body is often also referred to as a filter basket. This design has the advantage that the main body can be reused and only the woven filter fabric has to be exchanged when a change of the filter insert is necessary. In addition, the same main body can be used for different woven filter fabrics, as a result of which otherwise additionally necessary parts are saved.

It is considered particularly advantageous when the inner duct is closed at its axial end remote from the bearing section. This prevents unfiltered flowable medium from flowing into the region of the inner duct. In this respect, flowable medium can pass into the inner duct only via the filter structure, so that only filtered flowable medium can pass into the region of the inner duct. In an embodiment in which flow passes through the filter structure radially outwards from the radial inside, the inner duct is open in the direction of the heating hose and closed in the direction of the output opening. Unfiltered flowable medium then enters the inner duct and flows through the filter structure radially outwards and then in the direction of the output opening.

It is considered particularly advantageous when the woven filter fabric is arranged in the axial direction between the bearing section and a cover element protruding radially outwards relative to the woven filter fabric. By means of the cover element and the bearing section, the woven filter fabric is secured against sliding down from the filter section. It is considered particularly advantageous when the cover element is connected detachably to the main body. The cover element can thereby be removed in a simple manner in order to remove the woven filter fabric from the filter section, for example to exchange the woven filter fabric. The cover element can be connected to the filter section by means of a separate fastening element such as a screw. It is quite conceivable for the filter section to have a thread for screwing in the fastening screw.

In connection with the cover element, it is considered particularly advantageous when the cover element has a closed covering face for axially covering the woven filter fabric, an outer diameter of the covering face being larger than an outer diameter of the woven filter fabric. This prevents unfiltered flowable medium flowing under the woven filter fabric. In a development, the cover element has a cover section and a circumferential lateral section protruding in the direction of the woven filter fabric, the lateral section circumferentially surrounding the end region of the woven filter fabric adjacent to the cover section.

It is considered particularly advantageous when the further bearing section is formed by the cover element. The cover element thereby advantageously assumes a dual function, specifically the cover element is firstly used for radially supporting, in particular radially centering, the filter insert in the receiving section, and secondly for holding or securing the woven filter fabric on the main body. Furthermore, the cover element can also be used for closing the end of the inner duct of the filter insert.

In particular if there is a particularly tight fit between the bearing section and the inner side of the connection piece which circumferentially delimits the through-duct, and thus between the outer diameter of the bearing section and the diameter of the receiving section, it is possible that a high amount of force must be applied to pull the filter insert out of the receiving section. The filter insert can also get stuck if flowable medium such as adhesive, in particular old or burnt adhesive, has got into the interstice between the inner side of the connection piece and the outer side of the bearing section. Therefore, in a particularly preferred embodiment, the filter insert has a head section which protrudes in the axial direction relative to the receiving section, the head section having a structuring on a radially external outer face. This structuring can for example have a notch or even a circumferential cut. By means of the structuring, the head section can be gripped better, or a tool can even be applied to push the filter insert out of the receiving section. For example, the tool used can be a screwdriver. Such a head section can also be considered advantageous in that the filter insert can also be removed when in a hot state, since the filter insert can be gripped particularly well with a tool in the region of the head section.

It is considered particularly advantageous when the connection piece is an integral component of the heating hose.

In a particularly preferred embodiment, the connection piece is angled. In a preferred embodiment, the angle of the angled portion is about 45°. A 45-degree angle has proven advantageous in terms of the most flexible possible use of the connection piece.

In connection with a connection piece which forms an integral component of the heating hose, it is considered particularly advantageous when the receiving section of the connection piece and an axis of the stretched heating hose form an angle of about 45°. A 45-degree angle has proven advantageous in particular in an application device with a dosing valve, in which a longitudinal axis of a valve stem of the dosing valve and a coupling axis along which the connection piece is coupled to a connection socket or plug-in opening of the application device are likewise angled relative to one another by about 45°. As a result, an outgoing direction of the heating hose of about 0° to the longitudinal axis of the valve stem and an outgoing direction of the heating hose of about 90° to the longitudinal axis of the valve stem can be realized in a simple manner with the same components. To this end, the heating hose simply has to be rotated by 180° about the coupling axis in order to change from an outgoing direction of about 0° to an outgoing direction of about 90°.

In particular with an angled connection piece, it has proven advantageous when the heating hose is rotatable about a coupling axis of the connection piece when in the coupled state. The heating hose can thereby be changed in outgoing direction in relation to the application device in a simple manner. It is considered particularly advantageous when the connection piece is only rotatable when the flowable medium is in the unpressurized state.

It is considered particularly advantageous when the application device is an application head, the application head having a heating element for heating the application head and a, for example pneumatically or electromagnetically operated, dosing valve for dispensing the medium supplied to the application head onto the substrate.

To prevent cooling of the flowable medium in the region of the filter insert, it is considered particularly advantageous when, in relation to an axial extent of the filter insert, at least about 30%, preferably at least about 50%, particularly preferably at least about 70% of the filter insert are arranged inside the heated application device.

It is considered particularly advantageous when the opening size of the filter structure is less than about 0.2 mm, preferably less than about 0.1 mm, in particular less than about 0.05 mm. In a woven filter fabric, for example a woven wire fabric, the opening size corresponds to the mesh width and thus to the clear distance between the threads or wires.

The receiving section preferably has a diameter of about 8 mm to about 20 mm.

The bearing section preferably has an outer diameter of about 8 mm to about 20 mm, the outer diameter of the bearing section being smaller than or equal to the diameter of the receiving section.

The heating hose according to the present invention is used for supplying a flowable medium to an application device for applying the flowable medium to a substrate. The heating hose has an inner tube for conducting the flowable medium and a connection piece for connecting or coupling the heating hose to the application device. The connection piece has an inlet end, which is fluid-connected to the inner tube and has an inlet opening for the flowable medium, an outlet end, which has an outlet opening, and a through-duct, which extends from the inlet opening to the outlet opening, for the flowable medium, wherein the connection piece has, at its outlet end, a coupling section, which extends in a straight line in an axial direction, for coupling the heating hose to the application device, wherein a filter insert is inserted through the outlet opening in a straight line in the axial direction into a receiving section formed by the through-duct, wherein the filter insert has a filter structure through which flow can pass radially inwards from the radial outside or radially outwards from the radial inside, for filtering the flowable medium, and wherein the filter insert has a bearing section, which protrudes radially outwards relative to the filter structure, for radially supporting the filter insert in the receiving section.

The heating hose is in particular electrically heatable. Preferably, the heating hose is configured to keep the flowable medium at an operating temperature of about 20° C. to about 250° C. Preferably, the heating hose is pressure-stable up to an operating pressure of the flowable medium of up to about 100 bar, preferably up to about 400 bar. A hose length is preferably about 0.6 m to about 10 m. An inner tube of the hose used to conduct the flowable medium preferably has an inner diameter of about 6 mm to about 40 mm.

The above statements relating to the advantages and features of the application system and the advantageous embodiments thereof apply, mutatis mutandis, to the heating hose and vice versa.

### BRIEF DESCRIPTION OF THE DRAWING FIGURES

In the drawing figures below, the present invention is explained in more detail using one or more exemplary embodiments without being limited thereto.

FIG. 1 shows an application system for applying a flowable medium as is known from the prior art, in a side view.

FIG. 2 shows the application system according to FIG. 1 in a sectional view.

FIG. 3 shows an embodiment of the application system according to the present invention comprising a heating hose and an application head in a side view.

FIG. 4 shows the application system according to FIG. 3 in a sectional view.

FIG. 5 shows the heating hose of the application system according to FIG. 3 in an internal view.

FIG. 6 shows a connection piece of the heating hose according to FIG. 5 with a filter insert inserted therein in a perspective view.

FIG. 7 shows the arrangement according to FIG. 6 in a sectional view.

FIG. 8 shows a portion of the arrangement according to line VIII in FIG. 7.

FIG. 9 shows the connection piece without a filter insert in a sectional view.

FIG. 10 shows the application head of the application system in a connection region of the connection piece with the connection piece plugged in, in a sectional view.

FIG. 11 shows the connection region according to FIG. 10 without a connection piece in a sectional view.

FIG. 12 shows the filter insert in a perspective view.

FIG. 13 shows a main body of the filter insert according to FIG. 12 in a perspective view.

FIG. 14 shows a woven filter fabric of the filter insert according to FIG. 12 in a perspective view.

FIG. 15 shows a cover element of the filter insert according to FIG. 12 in a perspective view.

FIG. 16 shows the filter insert in a sectional view.

### DETAILED DESCRIPTION OF EXEMPLARY EMBODIMENTS

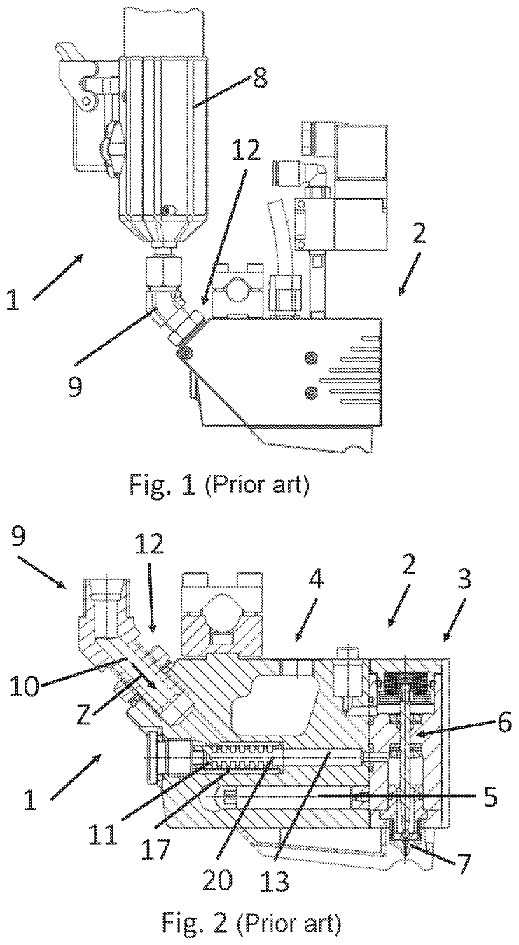

FIGS. 1 and 2 show an application system 1 for applying a flowable medium to a substrate, as is known from the prior art. The application system 1 has a heatable application head 2 for applying the flowable medium, for example a molten adhesive, to a substrate. The application head 2 has a spraying element 3 and a heating part 4. In the heating part 4, there is a heating element 5 in the form of a heating cartridge. The heating element 5 is used for the electrical heating of the application head 2 in order to keep the liquefied adhesive within the correct temperature range. In the spraying element 3 there is a dosing valve 6, which can be operated pneumatically. Via the dosing valve 6, a through-opening of an application nozzle 7 is opened and closed. The application system 1 further comprises a heating hose 8, the heating hose 8 being connected to the application head 2 via a connection piece 9. The connection piece 9 is connected to the application head 2 via an external and therefore externally accessible screw connection 12. The application head 2 has a bore in which a filter insert 11 is mounted. The flowable medium flowing into the application head 2 through the through-duct 10 is conducted into the filter housing via a connecting duct which opens obliquely into the filter housing. There, it flows from the radial outside to a filter structure, in the present case a woven filter fabric 17, and flows radially inwards through the woven filter fabric 17 into an inner duct 20 of the filter insert 11. The inner duct 20 opens into a supply duct 13 of the heating part 4, which in turn opens into the dosing valve 6. A disadvantage of this design is that the flow approaches the woven filter fabric 17 obliquely, as a result of which the woven filter fabric 17 is not loaded homogeneously. There is also the problem that, when the filter insert 11 is exchanged, any dirt can get into the supply duct 13, as a result of which the function of the dosing valve 6 could be impaired and/or the dispensed adhesive could contain impurities.

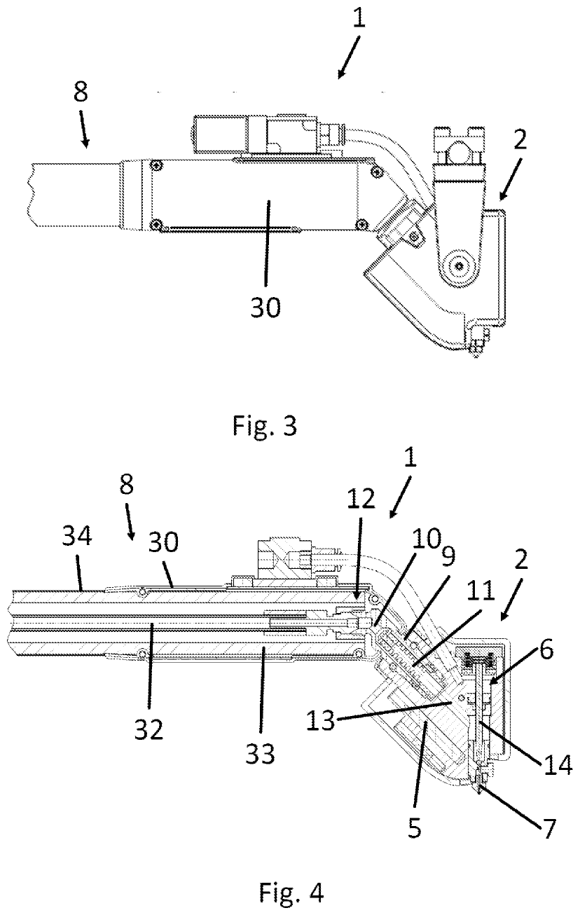

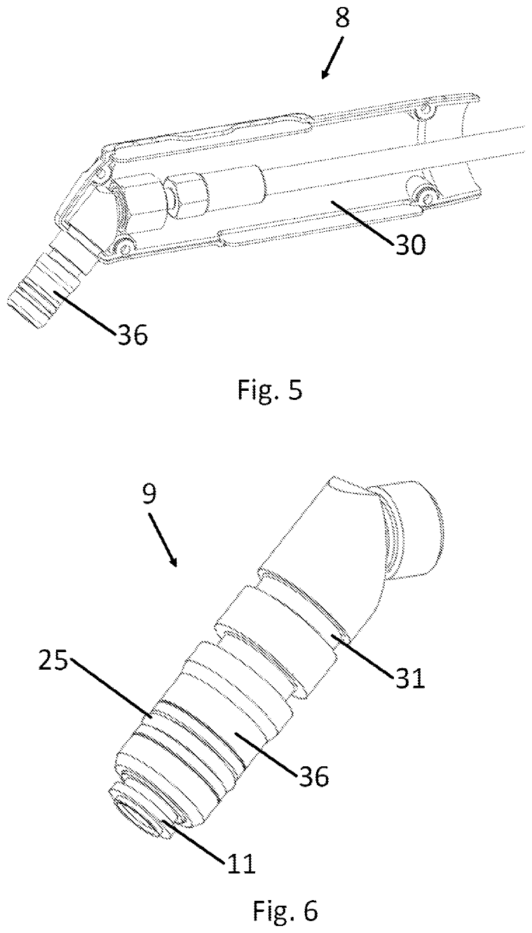

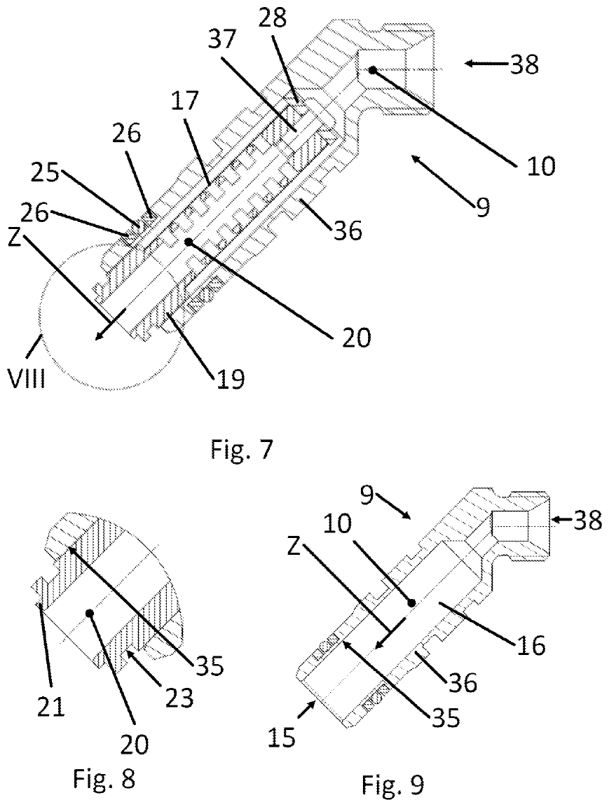

FIGS. 3 and 4 show an application system 1 according to the present invention. The application system 1 again has an application head 2 and a heating hose 8 connected to the application head 2. The application head 2 has an integrally formed base body which consists of aluminium and in which a dosing valve 6 and a heating element 5 are accommodated. The base body of the application head 2 has a supply duct 13 in the form of a bore, which in the present case opens into the dosing valve 6 at an angle of about 45° to a lift direction of a piston rod 14 of the dosing valve 6. The rigid, integrally formed connection piece 9 is likewise angled and has an inlet end having an inlet opening 38 (FIGS. 7, 9 and 10) for the adhesive, an outlet end formed at an angle to the inlet end and having an outlet opening 15 (FIG. 9), and a through-duct 10 which extends from the inlet opening 38 to the outlet opening 15 to conduct the adhesive through the connection piece 9. The adhesive flowing through an internal inner tube 32 of the heating hose 8 flows through the inlet opening 38 into the through-duct 10 of the connection piece 9. The outlet end is coupled to the application head 2 so that adhesive flowing out of the outlet opening 15 flows into the application head 2. The outlet end has a coupling section 36 (FIGS. 5-7 and 9) which extends in a straight line in an axial direction Z (FIGS. 7, 9 and 10) and via which the connection piece 9 is coupled to the application head 2. As can be seen in particular in FIG. 4, in the present case the filter insert 11 is not mounted in a bore formed in the application head 2 but in the through-duct 10 of the connection piece 9. The filter insert 11 is inserted through the outlet opening 15 in a straight line in the axial direction Z into the through-duct 10. The region of the through-duct 10 which receives the filter insert 11 thus forms a receiving section 16 (FIG. 9) for the filter insert 11. As can be seen in particular in FIG. 7, the filter insert 11 can be removed from the receiving section 16 or inserted in the axial direction Z from the outlet opening 15 when the connection piece 9 is disconnected from the application head 2.

The filter insert 11 has a filter structure through which flow can pass radially inwards from the radial outside for filtering the adhesive and a bearing section 19 (FIGS. 7, 12, 13 and 16) which protrudes radially outwards relative to the filter structure.

As can be seen in particular in FIG. 8, an outer diameter of the bearing section 19 corresponds to a diameter of the receiving section 16 so that the filter insert 11 is mounted radially in the receiving section 16 via the interaction of the bearing section 19 with the inner side 35 of the connection piece 9 which circumferentially delimits the through-duct 10. A radial clearance between the outer diameter of the bearing section 19 and the diameter of the receiving section 16 is selected such that the radial clearance is less than or equal to a mesh width or opening size of the filter structure. This prevents dirt passing unfiltered radially outwards through the filter insert 11 through the clearance between the bearing section 19 and the inner side 35 of the connection piece 9 which circumferentially delimits the through-duct 10 and getting into the application head 2.

In the present case, the filter structure is formed by a woven filter fabric 17 (FIGS. 7, 12 and 16). The woven filter fabric 17 as such is shown in more detail in FIG. 14. In the present case, the woven filter fabric 17 is hose-like and pushed onto a main body 18 (FIG. 13) of the filter insert 11. The main body 18 has the bearing section 19 and, adjacent thereto, a filter section for the woven filter fabric 17. The main body 18 has an inner duct 20 (FIGS. 7, 8, 10 and 16) which extends in the axial direction Z, the inner duct 20 being open at its end facing the application head 2 and closed at the opposite end. In the region of the filter section in which the woven filter fabric 17 is circumferentially arranged, the main body 18 has through-openings which open into the inner duct 20. The adhesive to be filtered flows through the woven filter fabric 17 radially inwards from the radial outside and passes via the through-openings into the inner duct 20 and from there into the supply duct 13 of the application head 2. The inner duct 20 is formed concentrically with the receiving section 16 and passes through the outlet opening 15. The adhesive thus flows not directly out of the outlet opening 15 but out of the open end of the inner duct 20 passing through the outlet opening, and from there directly into the supply duct 13.

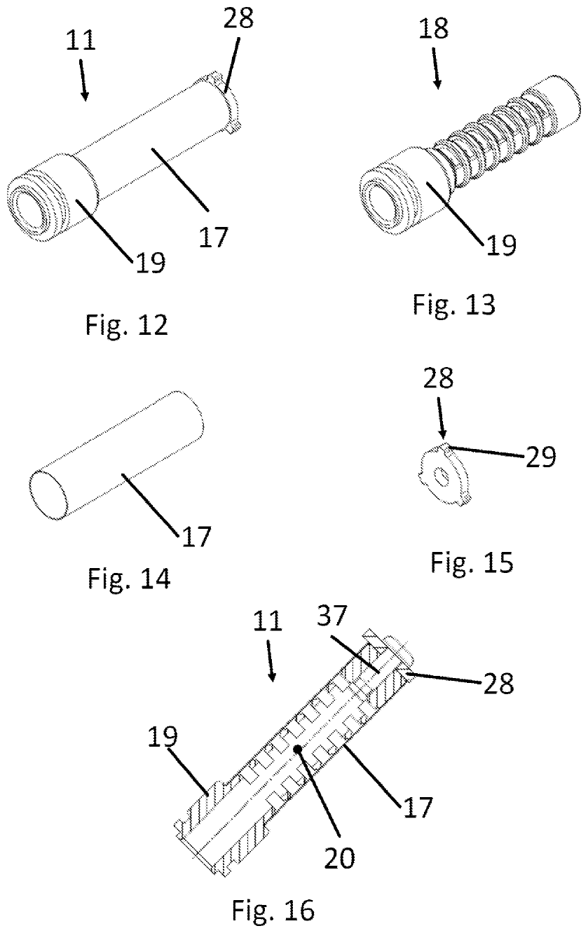

As can be seen in particular in FIG. 12, the filter insert 11 has a cover element 28, the woven filter fabric 17 being held between the bearing section 19 and the cover element 28. The cover element 28 is screw-fastened to the main body 18 at the end via a screw 37 (FIG. 16). The cover element 28 covers the woven filter fabric 17 in the axial direction Z, the cover element 28 protruding radially outwards relative to the woven filter fabric 17 over the full circumference. By means of the screw 37, the inner duct 20 is closed at its end facing the heating hose 8. The radially overhanging cover element 28 prevents the adhesive which flows in along the axial direction Z moving under the woven filter fabric 17. The cover element 28 has three radially outwardly protruding pegs 29 (FIG. 15), the outer diameters of which correspond approximately to the diameter of the receiving section 16. Additional radial support of the filter insert 11 is thereby achieved so that the filter insert 11 is supported radially on both sides of the woven filter fabric 17. This prevents jamming or tilting of the filter insert 11. The inflowing adhesive to be filtered can flow through between the pegs 29 and thus into the circular ring-shaped region between an outer side of the woven filter fabric 17 and the inner side 35 of the connection piece 9 which circumferentially delimits the through-duct 10. From there, the adhesive can then flow through the woven filter fabric 17 in the radial direction and thus pass filtered into the inner duct 20.

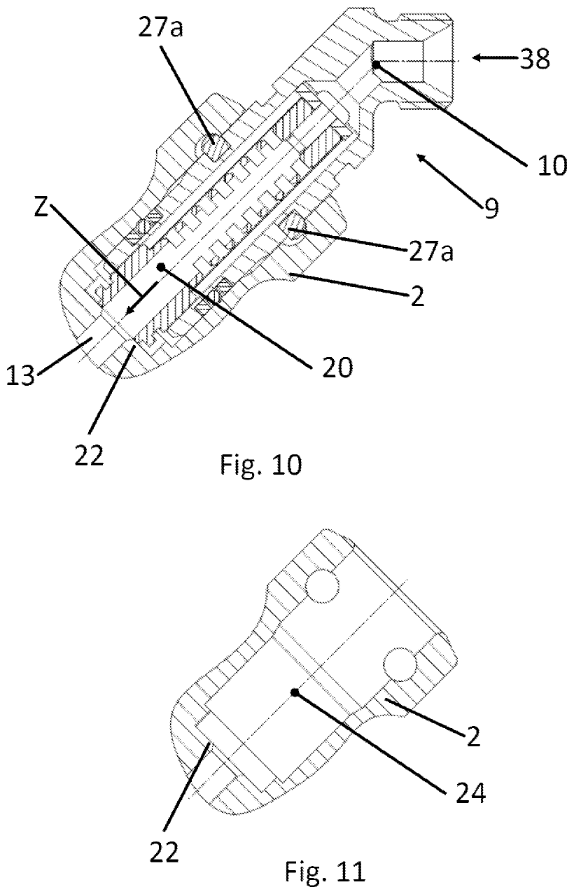

The connection piece 9 and the filter insert 11 have no separate securing means for securing the filter insert 11 in the receiving section 16. To ensure that the filter insert 11 does not slip out of the receiving section 16 during operation, the filter insert 11 has a supporting section 21 (FIG. 8), the filter insert 11 being arranged in the receiving section 16 such that the supporting section 21 protrudes in the axial direction Z relative to the receiving section 16 in the direction of the application head 2, and the supporting section 21 is supported axially on a counter bearing 22 of the plug-in opening of the application head 2. This can be seen in particular in FIG. 10. During operation of the application system 1, the adhesive pressure pushes the filter insert 11 in the axial direction Z in the direction of the application head 2 and against the counter bearing 22. To ensure that the filter insert 11 remains in the connection piece 9 of the heating hose 8 and is not pulled out after the heating hose 8 is disconnected from the application head 2, the end face of the supporting section 21 which presses against the counter bearing 22 of the connection piece 9 in the application head 2 is small in relation to the contact face between the bearing section 19 and the inner side 35 of the connection piece 9. The static friction between the supporting section 21 and the counter bearing 22 is thereby much lower than the force action between the bearing section 19 and the connection piece 9 owing to adhesive penetrating between the aforementioned faces. This ensures that the filter insert 11 reliably remains in the receiving section 16 of the connection piece 9 after the connection piece 9 is disconnected from the application head 2. In this respect, there is a force fit or frictional fit between the bearing section 19 and the inner side 35 of the connection piece 9, as a result of which the filter insert 11 is held in the receiving section 16, in particular when adhesive passes into the interstice between the bearing section 19 and the inner side 35 of the connection piece 9 which circumferentially delimits the through-duct 10 during operation.

To facilitate removal of the filter insert 11 from the receiving section 16, the filter insert 11, in the present case the main body 18, has a head section which protrudes in the axial direction Z relative to the receiving section 16, the supporting section 21 being a component of the head section, and the head section having a structuring in the form of a circumferential cut 23 (FIG. 8) on a radially external outer face. This cut 23 allows a tight filter insert 11 to be removed by means of a tool, for example a screwdriver.

The application head 2 has a plug-in opening 24 (FIG. 11) for plugging in the coupling section 36 of the connection piece 9. To facilitate the coupling of the connection piece 9 to the application head 2, the coupling section 36 has an outer diameter which widens in steps in the direction of the heating hose 8 and thus counter to the axial direction Z, and the plug-in opening 24 has a corresponding inner diameter which widens in steps in the direction of the heating hose 8 and thus counter to the axial direction Z. In the present case, the plug-in opening 24 is in the form of a stepped bore. By means of these stepped diameters, self-centering is achieved when the connection piece 9 is plugged into the plug-in opening 24. At a smaller of the two outer diameters of the coupling section 36, a static seal 25 (FIGS. 6 and 7) is attached, which prevents adhesive being able to escape between the outer face of the coupling section 36 and the inner side of the plug-in opening 24 during operation. In the present case, this static seal 25 consists of an O-ring which is arranged between two supporting rings 26 (FIG. 7). The steps of the coupling section 36 and of the plug-in opening 24 also have the advantage that this seal 25 only has to be shifted a relatively small distance when the connection piece 9 is plugged in, which means reduced wear of the seal 25.

To prevent inadvertent removal or detachment of the connection piece 9 from the application head 2, the connection piece 9 is secured axially in the plug-in opening 24 by means of a U-shaped closure slide which is plugged in transversely to the plug-in direction of the connection piece 9. The closure slide has two limbs 27a, these two limbs 27a preventing axial shifting of the connection piece 9 in the axial direction in relation to the application head 2, as can be seen in particular in FIG. 10.

In the present case, the connection piece 9 is angled such that an axis of the coupling section 36 forms an angle of about 45° with an axis of the end section forming the inlet end.

As can be seen in FIGS. 4 and 5, the connection piece 9 is an integral component of the heating hose 8 in the present case. The heating hose 8 has a flexible heating hose body. The heating hose body has a high-pressure hose, the high-pressure hose having an internal flexible inner tube 32 made of plastic to conduct the liquefied adhesive and a reinforcement (not shown in detail), for example in the form of steel braiding, which surrounds the inner tube 32, in order to achieve the necessary pressure stability. Heating conductors (not shown in detail) are wound around the high-pressure hose, for example in the form of a heating band wound helically around the high-pressure hose. The heating hose body also has a thermal insulation layer 33 consisting of a thermal insulation material, the heating conductors being formed between the thermal insulation layer 33 and the high-pressure hose. The heating hose body also has a flexible outer sheath 34 which consists of a woven polyamide fabric and surrounds the thermal insulation layer 33. The inlet end of the connection piece 9 remote from the outlet end is connected fluid-tightly and fixedly to the inner tube 32 via a screw connection 12 which is formed in the interior of the heating hose 8 and is therefore not accessible from the outside, such that the adhesive flowing in the inner tube 32 flows through the inlet opening 38 into the through-duct 10. Owing to the angled design of the connection piece 9, the coupling section 36 and thus the axis of the receiving section 16 are likewise angled by about 45° relative to the inner tube 32 when the heating hose 8 is stretched.

At its end having the connection piece 9, the heating hose 8 has an external rigid end cap 30, which is composed of two half-shells. The end cap 30 extends over the screw connection 12 into the angled region of the connection piece 9 and engages there with a circumferential groove 31 (FIG. 6) of the connection piece 9. By means of this design, the end cap 30 prevents rotation of the connection piece 9 relative to the inner tube 32 and thus loosening of the screw connection 12 between the inner tube 32 and the connection piece 9.

In the present case, the heating conductors and the thermal insulation layer 33 extend only over the screw connection 12 between the inner tube 32 and the connection piece 9. Inside the end cap 30, additional insulation can be attached in the region of the screw-fastening of the connection piece 9 to the inner tube 32. In contrast, the angled region of the connection piece 9, which region also has the receiving section 16 for the filter insert 11, is insulated very little or not at all and protrudes relative to the end cap 30. As can be seen in particular in FIGS. 4 and 10, at least about 70% of the filter insert 11, in relation to an axial extent of the filter insert 11, are arranged inside the application head 2, specifically the base body of the application head 2. This prevents the adhesive cooling too much in the region of the receiving section 16 or in the region of the filter insert 11. This has the advantage that in the event of an interruption of operation, the adhesive present in the connection region between the heating hose 8 and the application head 2 cools down only insignificantly, since only a short part of the transition path of the adhesive between the heating hose 8 and the application head 2 is not heated, and approximately the entire stretch is insulated at least slightly by the end cap 30 extending approximately as far as the application head 2, as can be seen in particular in FIG. 4.

The design shown in the drawing figures has, inter alia, the following advantages: Because the receiving section 16 for the filter insert 11, in this respect the filter housing, is formed in the connection piece 9, only filtered adhesive passes into the application head 2. As a result, any contamination of the application head 2 during exchange of the filter insert 11 is avoided. After the filter insert 11 is removed from the connection piece 9, it can be the case that some of the dirt remains in the connection piece 9 or through-duct 10. To remove this dirt, the connection piece 9 and/or the entire heating hose 8 can be flushed. It is quite conceivable here for a small amount of new adhesive to be pumped through the heating hose 8 and then disposed of. Any residual dirt is then removed together with the disposed of adhesive before a new filter insert 11 is inserted into the connection piece 9.

The solution according to the invention also has the advantage that an exchange of the filter insert 11 or the woven filter fabric 17 can take place completely outside the application head 2. An exchange of the filter insert 11 can thus take place independently of the application head 2. Effort spent on readjusting the application head 2 is thereby avoided. Owing to the flexible heating hose 8, the filter insert 11 can be changed in a region which is easily accessible to the operator.

Since the filter insert 11 is arranged coaxially with the receiving section 16, a particularly uniform flow through the woven filter fabric 17 is achieved over the entire circumferential face. As a result, the filter area of the woven filter fabric 17 can be used more effectively, and the duration until a change of the filter insert 11 or woven filter fabric 17 is necessary longer.

That which is claimed is:

1-15. (canceled)

16. An application system for applying a flowable medium to a substrate, wherein the application system has a heatable application device for applying the flowable medium to the substrate, a heating hose for supplying the flowable medium to the application device, and a filter insert, wherein the heating hose has an inner tube for conducting the flowable medium, wherein the application device and the heating hose are coupled to one another detachably via a connection piece, wherein the connection piece has an inlet end, which is fluid-connected to the inner tube and has an inlet opening for the flowable medium, an outlet end, which has an outlet opening, and a through-duct, which extends from the inlet opening to the outlet opening, for the flowable medium, wherein the connection piece has, at its outlet end, a coupling section, which extends in a straight line in an axial direction and is coupled to the application device, wherein the filter insert is inserted through the outlet opening in a straight line in the axial direction into a receiving section formed by the through-duct, wherein the filter insert has a filter structure through which flow can pass radially inwards from the radial outside or radially outwards from the radial inside, for filtering the flowable medium, and wherein the filter insert has a bearing section, which protrudes radially outwards relative to the filter structure, wherein the bearing section is arranged at least partially in the receiving section, for radially supporting the filter insert in the receiving section.

17. The application system according to claim 16, wherein the receiving section has a diameter which is wider than the adjacent section of the through-duct in the direction of the heating hose.

18. The application system according to claim 16, wherein the filter insert has a supporting section, wherein the filter insert is arranged in the receiving section such that the supporting section protrudes in the axial direction relative to the receiving section in the direction of the application device, wherein the supporting section is supported axially on a counter bearing of the application device.

19. The application system according to claim 16, wherein the bearing section is directly adjacent to an inner side of the connection piece which circumferentially delimits the through-duct, wherein a radial clearance between the bearing section and the inner side of the connection piece is smaller than an opening size of the filter structure.

20. The application system according to claim 16, wherein the coupling section is plugged into a plug-in opening of the application device, wherein the coupling section has an outer diameter which widens in steps, and the plug-in opening has a corresponding inner diameter which widens in steps.

21. The application system according to claim 16, wherein the bearing section is formed in the axial direction between an end, facing the application device, of the filter insert and the filter structure.

22. The application system according to claim 16, wherein the filter insert has a further bearing section, wherein the filter structure is formed between the bearing section and the further bearing section, wherein the further bearing section protrudes radially outwards relative to the filter structure, for radially supporting the filter insert in the receiving section.

23. The application system according to claim 22, wherein the filter insert has a main body and a woven filter fabric forming the filter structure, wherein the main body has a filter section and the bearing section, wherein the bearing section and the filter section are adjacent to one another in the axial direction, wherein the main body has an inner duct, which passes through the bearing section and extends into the filter section, wherein the main body has through-openings which open into the inner duct in the region of the filter section, wherein the woven filter fabric is arranged in the region of the filter section and circumferentially surrounds the filter section.

24. The application system according to claim 23, wherein the woven filter fabric is arranged in the axial direction between the bearing section and a cover element protruding radially outwards relative to the woven filter fabric to secure the woven filter fabric to the main body, wherein the cover element is connected detachably to the main body.

25. The application system according to claim 24, wherein the cover element forms the further bearing section.

26. The application system according to claim 16, wherein the filter insert has a head section which protrudes in the axial direction relative to the receiving section, wherein the head section has a structuring on a radially external outer face.

27. The application system according to claim 16, wherein the connection piece is an integral component of the heating hose.

28. The application system according to claim 16, wherein, in relation to an axial extent of the filter insert, at least about 30% of the filter insert is arranged inside the application device.

29. The application system according to claim 16, wherein the application device is an application head, wherein the application head has a heating element for heating the application head and an operatable dosing valve for dispensing the flowable medium supplied to the application head onto the substrate.

30. A heating hose for supplying a flowable medium to an application device for applying the flowable medium, wherein the heating hose has an inner tube for conducting the flowable medium and a connection piece, wherein the connection piece has an inlet end, which is fluid-connected to the inner tube and has an inlet opening for the flowable medium, an outlet end, which has an outlet opening, and a through-duct, which extends from the inlet opening to the outlet opening, for the flowable medium, wherein the connection piece has, at its outlet end, a coupling section, which extends in a straight line in an axial direction, for coupling the heating hose to the application device, wherein a filter insert is inserted through the outlet opening in a straight line in the axial direction into a receiving section formed by the through-duct, wherein the filter insert has a filter structure through which flow can pass radially inwards from the radial outside or radially outwards from the radial inside, for filtering the flowable medium, and wherein the filter insert has a bearing section, which protrudes radially outwards relative to the filter structure, wherein the bearing section is arranged at least partially in the receiving section, for radially supporting the filter insert in the receiving section.
